(19) United States
(12) Patent Application Publication
(10) Pub. No.: US 2017/0188082 A1
(43) Pub. Date: Jun. 29, 2017

(54) A METHOD AND A DEVICE FOR EXCHANGING DATA BETWEEN A SMART DISPLAY TERMINAL AND MOTION-SENSING EQUIPMENT

(71) Applicants: Yong WANG, Hangzhou, Zhejiang (CN); Ke XU, Hangzhou, Zhejiang (CN); Alibaba Group Holding Limited, George Town (KY)

(72) Inventors: Yong Wang, Hangzhou (CN); Ke Xu, Hangzhou (CN)

(21) Appl. No.: 15/313,518

(22) PCT Filed: May 14, 2015
(86) PCT No.: PCT/CN2015/078917

§ 371 Date: Nov. 22, 2016

(30) Foreign Application Priority Data
May 30, 2014 (CN) 201410238796.4

(51) Int. Cl. H04N 21/422; G06F 3/01; G06Q 30/06; H04N 21/482; H04N 5/44; H04N 21/436; G06K 9/00

(52) U.S. Cl. CPC H04N 21/42222; H04N 21/43615; G06F 3/017; G06K 9/00335; H04N 21/42201; H04N 21/482; H04N 5/4403; G06Q 30/0643; G05B 2219/23021

(57) ABSTRACT

Exchanging information between a smart display terminal and motion-sensing equipment includes: reading equipment data uploaded by motion-sensing equipment on the basis of a smart display terminal; converting said equipment data to standardized motion-sensing data; and reading said standardized motion-sensing data.

### CROSS REFERENCE TO OTHER APPLICATIONS

This application claims priority to International (PCT) Application No. PCT/CN15/078917 entitled A METHOD AND A DEVICE FOR EXCHANGING DATA BETWEEN A SMART DISPLAY TERMINAL AND MOTION-SENSING EQUIPMENT, filed May 14, 2015 which is incorporated herein by reference for all purposes, which claims priority to People's Republic of China Patent Application No. 201410238796.4 entitled A METHOD AND A DEVICE FOR EXCHANGING DATA BETWEEN A SMART DISPLAY TERMINAL AND MOTION-SENSING EQUIPMENT, filed May 30, 2014 which is incorporated herein by reference for all purposes.

### FIELD OF THE INVENTION

The present application relates to a field of smart display terminal technology. In particular, it relates to a method for exchanging data between a smart display terminal and motion-sensing equipment. The present application also relates to a device which is for exchanging data between a smart display terminal and motion-sensing equipment, motion-sensing equipment middleware for exchanging data between a smart display terminal and motion-sensing equipment, and a software development kit for exchanging data between a smart display terminal and motion-sensing equipment.

### BACKGROUND OF THE INVENTION

Smart television terminals are terminal devices such as smart televisions or television boxes (such as Apple TV, Xiaomi Box, LeEco TV, and Alibaba's Tmall Magic Box) that can support smart operating systems (such as iOS, Android, and Alibaba TV OS). While users are able to enjoy ordinary television content, they can also install or uninstall various kinds of applications and games and thereby expand and upgrade television functions. This year, as smart televisions have undergone rapid development, various applications applied to smart televisions have also developed rapidly. This development has especially taken the form of game diversification and enrichment. In addition, in order to meet user demand for smart television games, all kinds of external products adapted to smart television applications have appeared. Examples include controllers, remote controls, mice, and motion-sensing equipment (devices that use in-built sensors to detect user actions or statuses).

In the prior art, smart television terminal operating systems originate from smartphone operating systems. Generally, smart television terminal operating systems support only one set of motion-sensing equipment. To achieve a multi-player game, one first has to develop multi-player-mode motion-sensing games, in which everyone requires their own specific gaming controller (such as the multi-player games Sports Jiajia and Xiao Bawang). By directly reading the differently marked data transmitted from its game controllers, the game differentiates between different game controllers and thereby achieves a game-supporting multi-player mode.

The above-described method provided by the prior art for managing motion-sensing equipment on smart television terminals has obvious drawbacks. Under the prior art, the software or games installed on a smart television terminal can only achieve data interaction with motion-sensing equipment of one or a few specific types. Compatibility is very limited. In addition, the software developers can only develop one or a series of games based on specific motion-sensing equipment. User-developed games can only be used on specific motion-sensing equipment. The interfaces are not uniform. A user that purchases one type of motion-sensing equipment can only play one type of game or a series of games corresponding to the motion-sensing equipment.

Moreover, once the game is out of date, and the user wishes to play another game, they will have to purchase new motion-sensing equipment. The motion-sensing equipment is discarded and thus resources are wasted.

### SUMMARY OF THE INVENTION

The present application provides a method for exchanging data between a smart display terminal and motion-sensing equipment in order to solve the problems of poor compatibility and non-uniform interfaces of existing methods. The present application also provides a device that is for exchanging data between a smart display terminal and motion-sensing equipment, motion-sensing equipment middleware for exchanging data between a smart display terminal and motion-sensing equipment and a software development kit for exchanging data between a smart display terminal and motion-sensing equipment.

The present application provides a method for exchanging data between a smart display terminal and motion-sensing equipment. It comprises:

reading equipment data uploaded by motion-sensing equipment on the basis of a smart display terminal;

converting said equipment data to standardized motion-sensing data;

using an application to read said standardized motion-sensing data.

Optionally, said equipment data uploaded by motion-sensing equipment and read on the basis of a smart display terminal is received through interface driving modules;

wherein said interface driving modules comprise: USB drivers, WiFi drivers, and/or Bluetooth drivers.

Optionally, said converting of said equipment data to standardized motion-sensing data comprises:

acquiring the data format standard used by the motion-sensing equipment corresponding to said equipment data;

resolving said equipment data according to said data format standard and generating motion-sensing data;

converting said motion-sensing data on the basis of a preset conversion algorithm into standardized motion-sensing data.

Optionally, said conversion algorithm is based on the relationship between the motion-sensing data format and the standardized motion-sensing data format and is established for said motion-sensing data format.

Optionally, prior to said application reading said standardized motion-sensing data, it comprises:

packaging said standardized motion-sensing data according to a private protocol to obtain motion-sensing data packets;

sending said motion-sensing data packets to an application.

Optionally, said application reading said standardized motion-sensing data comprises:

an application receiving said motion-sensing data packets;

said application resolving said motion-sensing data packets in accordance with said private protocol to obtain standardized motion-sensing data.

Optionally, said application receiving said motion-sensing data packets specifically is said application receiving said motion-sensing data packets via an application programming interface.

Optionally, said smart terminal sends instructions to said motion-sensing equipment via said application programming interface.

The present application provides a device for exchanging information between a smart display terminal and motion-sensing equipment. It comprises:

an equipment data reading unit, for reading equipment data uploaded by motion-sensing equipment on the basis of a smart display terminal;

a data conversion unit, for converting said equipment data into standardized motion-sensing data;

a data calling unit, for implementing the reading by an application of said standardized motion-sensing data.

Optionally, said data conversion unit comprises:

a data standard acquiring subunit, for acquiring the data format standard used by the motion-sensing equipment corresponding to said equipment data;

an equipment data resolving subunit, for resolving said equipment data according to said data format standard and generating motion-sensing data;

a standardized motion-sensing data generating subunit, for converting said motion-sensing data into standardized motion-sensing data on the basis of a preset conversion algorithm.

Optionally, said device for exchanging information between a smart display terminal and motion-sensing equipment comprises:

a data packaging unit, for packaging said standardized motion-sensing data according to a private protocol and obtaining motion-sensing data packets;

a data sending unit, for sending said motion-sensing data packets to an application.

Optionally, said data calling unit comprises:

a data receiving subunit, the application receiving said motion-sensing data packets;

a data resolving subunit, said application resolving said motion-sensing data packets in accordance with said private protocol to obtain standardized equipment data.

The present application further provides a motion-sensing equipment middleware for exchanging information between a smart display terminal and motion-sensing equipment. It comprises: a driving and linking unit, a data standardizing unit, a motion-sensing equipment management unit, and a data communication unit;

said driving and linking unit being for reading equipment data uploaded by the motion-sensing equipment based on the smart display terminal and for sending commands issued by an application;

said data standardizing unit being for converting said equipment data into standardized motion-sensing data;

said motion-sensing equipment management unit being for managing the motion-sensing equipment that is connected to said smart display terminal and the equipment data corresponding to the motion-sensing equipment;

said data communication unit performing data communication with said application on the basis of inter-process communication.

Optionally, said data standardizing unit comprises:

a data format standard acquiring subunit, for acquiring the data format standard used by the motion-sensing equipment corresponding to said equipment data;

a data resolving subunit, for resolving said equipment data according to said data format standard and generating motion-sensing data;

a data conversion subunit, for converting said motion-sensing data on the basis of a preset conversion algorithm into standardized motion-sensing data.

Optionally, said motion-sensing equipment management unit comprises:

a resolving subunit, for resolving said standardized motion-sensing data and obtaining equipment characteristic information;

a storage subunit, for storing said standardized motion-sensing data in a data storage area corresponding to said equipment characteristic information.

Optionally, said data communication unit comprises:

a motion-sensing data packet generating subunit, for packaging said standardized motion-sensing data according to a private protocol to obtain motion-sensing data packets;

a motion-sensing data packet sending subunit, for sending said motion-sensing data packets to said application;

an instruction data packet receiving subunit, for receiving instruction data packets sent by said application; and

an instruction data packet resolving subunit, for resolving said instruction data packets into standardized instruction data according to a private protocol.

Optionally, said inter-process communication comprises: message queuing, memory sharing, or sockets.

The present application further provides a software development kit for exchanging information between a smart display terminal and motion-sensing equipment. It comprises: a data communication unit, an event management unit, a motion-sensing equipment management unit, and an interface providing unit;

said data communication unit performing data communication with said motion-sensing equipment middleware on the basis of inter-process communication;

said event management unit implementing operational control over said application based on various preset motion-sensing events;

said motion-sensing equipment management unit, for managing the motion-sensing equipment that is connected to said smart display terminal and the equipment data corresponding to the motion-sensing equipment;

said interface providing unit, for providing application programming interfaces to the application.

Optionally, said data communication unit comprises:

a motion-sensing data packet receiving subunit, for receiving motion-sensing data packets sent by said motion-sensing equipment middleware;

a motion-sensing data packet resolving subunit, for resolving said motion-sensing data packets according to a private protocol and obtaining standardized motion-sensing data;

an instruction data packet generating subunit, for packaging said instruction data according to the private protocol and obtaining instruction data packets;

an instruction data packet sending subunit, for sending said instruction data packets to said motion-sensing equipment middleware.

Optionally, said motion-sensing equipment management unit comprises:

a motion-sensing event resolving subunit, for resolving said motion-sensing event and for obtaining equipment characteristic information and standardized motion-sensing data;

a motion-sensing equipment acquiring subunit, for using said equipment characteristic information to acquire the motion-sensing equipment corresponding to the equipment characteristic information from a motion-sensing equipment list;

a data storage subunit, for storing said standardized motion-sensing data;

the data storage area corresponding to said equipment characteristic information.

Optionally, said interface providing unit comprises:

an interface implementing subunit implementing said application programming interface on the basis of said motion-sensing equipment management unit;

an interface encapsulation subunit, for packaging said application programming interface, for compiling it into a library file, and for exporting it.

The present application has the following advantages over the prior art:

The method for exchanging data between a smart display terminal and motion-sensing equipment provided by the present application is minimally constrained and conserves resources.

The method for exchanging data between a smart display terminal and motion-sensing equipment provided by the present application comprises: reading equipment data uploaded by motion-sensing equipment on the basis of a smart display terminal; converting said equipment data to standardized motion-sensing data; and an application reading said standardized motion-sensing data.

The aforesaid method provided by the present application can convert the equipment data collected by motion-sensing equipment manufactured by different equipment manufacturers to standardized motion-sensing data with a unified data formatting standard, enabling applications installed on smart display terminals to have good compatibility, i.e., to be compatible with motion-sensing equipment that has different data formatting standards and that was manufactured by different equipment manufacturers. In addition, the aforesaid method provided by the present application provides software developers with a unified interface based on said standardized motion-sensing data.

The present application additionally provides a motion-sensing equipment middleware for exchanging information between a smart display terminal and motion-sensing equipment. It comprises a driving and linking unit, a data standardizing unit, a motion-sensing equipment management unit, and a data communication unit. Said driving and linking unit is for reading equipment data uploaded by the motion-sensing equipment based on the smart display terminal and for sending commands issued by an application. Said data standardizing unit is for converting said equipment data into standardized motion-sensing data. Said motion-sensing equipment management unit is for managing the motion-sensing equipment that is connected to said smart display terminal and the equipment data corresponding to the motion-sensing equipment. Said data communication unit performs data communication with said application on the basis of inter-process communication.

Said motion-sensing equipment middleware provided by the present application converts the equipment data uploaded by motion-sensing equipment that has different data formatting standards and that was manufactured by different equipment manufacturers to standardized motion-sensing data with a unified data formatting standard and makes it available for application calling, enabling applications to have good compatibility, i.e., to be compatible with motion-sensing equipment that has different data formatting standards and that was manufactured by different equipment manufacturers.

The present application further provides a software development kit for exchanging information between a smart display terminal and motion-sensing equipment. It comprises: a data communication unit, an event management unit, a motion-sensing equipment management unit, and an interface encapsulation unit. Said data communication unit performs data communication with said motion-sensing equipment middleware on the basis of inter-process communication. Said event management unit implements operational control over said application based on various preset motion-sensing events. The motion-sensing equipment management unit is for managing the motion-sensing equipment that is connected to said smart display terminal and the equipment data corresponding to the motion-sensing equipment. The interface providing unit is for providing application programming interfaces to the application.

Said software development kit provided by the present application provides software developers with a unified application programming interface based on standardized motion-sensing data with a unified data formatting standard, making it unnecessary for software developers to develop software or games corresponding to different data formatting standards for the same type of software or game. It thereby conserves resources.

### DESCRIPTION OF THE DRAWINGS

Various embodiments of the invention are disclosed in the following detailed description and the accompanying drawings.

FIG. 1 is a flowchart of a method for exchanging data between a smart display terminal and motion-sensing equipment as provided by a first embodiment of the present application.

FIG. 2 is a diagram of a device for exchanging data between a smart display terminal and motion-sensing equipment as provided by a second embodiment of the present application.

FIG. 3 is a diagram of motion-sensing equipment middleware for exchanging data between a smart display terminal and motion-sensing equipment as provided by a third embodiment of the present application.

FIG. 4 is a diagram of a software development kit for exchanging data between a smart display terminal and motion-sensing equipment as provided by a fourth embodiment of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

So that the present application may be fully understood, many specific details are presented in the following descriptions. However, the present application may be implemented in many ways that are different from those described here. Persons skilled in the art may make similar extensions without violating the content of the present application. Therefore, the present application is not limited by the specific embodiments disclosed below.

The present application provides a method for exchanging data between a smart display terminal and motion-sensing equipment. The present application further provides a device that is for exchanging data between a smart display terminal and motion-sensing equipment, motion-sensing equipment middleware for exchanging data between a smart display terminal and motion-sensing equipment, and a software development kit for exchanging data between a smart display terminal and motion-sensing equipment.

A method for exchanging data between a smart display terminal and motion-sensing equipment is explained in detail below in light of the drawings and specific embodiments.

### Embodiment 1

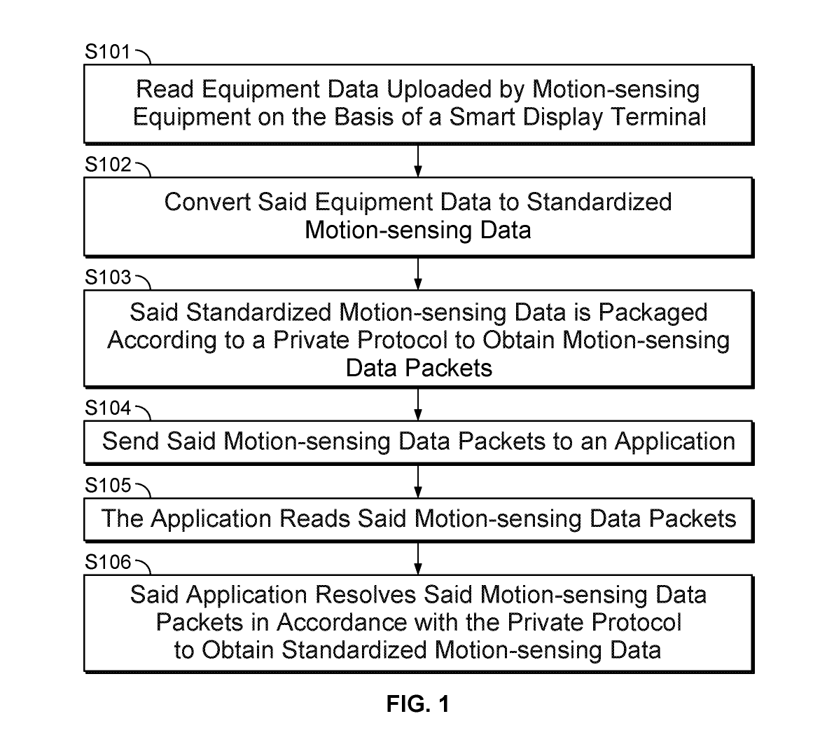

Refer to FIG. 1, which presents a flowchart of a method for exchanging data between a smart display terminal and motion-sensing equipment as provided by a first embodiment of the present application.

The method for exchanging data between a smart display terminal and motion-sensing equipment as described by the present embodiment comprises the steps below:

S101: Read equipment data uploaded by motion-sensing equipment on the basis of a smart display terminal.

Said smart display terminal refers to an equipment terminal that is for playing display functions and on which systems and applications can be installed and run. Examples include smart television terminals and PCs. Said motion-sensing equipment comprises motion-sensing controllers, smart mobile terminals, and wearable equipment. Said equipment data comprises data collected by built-in sensors in motion-sensing equipment. In addition, said equipment data further comprises equipment information data (equipment ID of the motion-sensing equipment, equipment manufacturer ID, equipment name and sensor model, type, etc.).

In the present embodiment, the description is given using the example of a smart television terminal. Other types of smart display terminals are similar to smart television terminals. It is sufficient to refer to the method for exchanging data between a smart display terminal and motion-sensing equipment as provided below by the present embodiment. The present embodiment will not list each and every one.

Prior to “read equipment data uploaded by motion-sensing equipment on the basis of a smart display terminal,” as stated in this step, the process whereby said motion-sensing equipment uploads said equipment data comprises the following two steps: 1) The motion-sensing equipment collects equipment data. Built-in sensors in the motion-sensing equipment collect the equipment data of the current motion-sensing equipment. 2) Said motion-sensing equipment uploads said equipment data to said smart television terminal.

After the step of said motion-sensing equipment uploading said equipment data is completed, the equipment data uploaded by the motion-sensing equipment is read based on the smart display terminal. Said equipment data uploaded by the motion-sensing equipment that is read based on the smart display terminal is received through an interface driving module, wherein said interface driver module may be: a USB driver, a WiFi driver, or a Bluetooth driver.

After “read equipment data uploaded by motion-sensing equipment on the basis of a smart display terminal,” as stated in this step is completed, the step of converting said equipment data to standardized motion-sensing data is carried out.

S102: Convert said equipment data to standardized motion-sensing data.

Said converting of equipment data to standardized motion-sensing data comprises:

1) Acquire the data formatting standard used by the motion-sensing equipment corresponding to said equipment data.

Said equipment data comprises the data collected by in-built sensors in the motion-sensing equipment and equipment information data. Said equipment information data comprises: equipment ID of the motion-sensing equipment, equipment manufacturer ID, equipment name and sensor model, type, etc. The equipment ID, equipment manufacturer ID, equipment name and sensor model, and type of motion-sensing equipment may also have different data format standards for the corresponding equipment data.

In the present step, the data format standard that corresponds to the motion-sensing equipment and that is provided by the motion-sensing equipment factory or the data format standard that corresponds to the built-in sensor in said motion-sensing equipment and that is provided by the sensor factory is acquired, and said data format standard is saved.

2) Said equipment data is analyzed according to said data format standard to generate motion-sensing data.

Said motion-sensing data refers to data that can represent the motion characteristics of motion-sensing equipment. The objective of this step lies in converting through analysis and computation that part of the equipment data that is collected by built-in sensors in the motion-sensing equipment into motion-sensing data that can represent motion-sensing equipment motion characteristics or user motion-sensing actions.

3) Said motion-sensing data is converted on the basis of a preset conversion algorithm into standardized motion-sensing data.

Said standardized data is motion-sensing data that represents motion-sensing equipment motion characteristics or user motion-sensing actions and that is based on a unified standard. The objective of this step lies in converting motion-sensing data with different data format standards into motion-sensing data with a unified data format standard, i.e., standardized motion-sensing data. Said conversion algorithm is written on the basis of the relationship between the data format standard of said motion-sensing data and the data format standard of standardized motion-sensing data.

After said motion-sensing data is converted into standardized motion-sensing data in accordance with the three steps described above, said standardized motion-sensing data is sent to an application.

S103: Said standardized motion-sensing data is packaged according to a private protocol to obtain motion-sensing data packets.

Before said standardized motion-sensing data is sent to an application, said standardized motion-sensing data is packaged according to a private protocol to obtain motion-sensing data packets. After said motion-sensing data packets are obtained, said motion-sensing data packets are sent to the application. In this step, said step of packaging said standardized motion-sensing data according to a private protocol is not the main point of the present embodiment and will not be discussed further here.

S104: Send said motion-sensing data packets to an application.

Sending said motion-sensing data packets to an application is based on forms of inter-process communication. Said forms of inter-process communication comprise: message queues, shared memory, and sockets. In addition, methods other than those in the present embodiment may be employed to send said motion-sensing data packets to an application. No restriction is imposed in this regard.

S105: The application receives said motion-sensing data packets.

The application receives the motion-sensing data packets sent through a form of inter-process communication. After said motion-sensing data packets are received, said motion-sensing data packets are resolved into standardized equipment data.

S106: Said application resolves said motion-sensing data packets in accordance with the private protocol to obtain standardized motion-sensing data.

In order to ensure the consistency and validity of the data of both the motion-sensing equipment middleware and the application, a unified data standard, namely a private protocol, is reached between the motion-sensing equipment middleware and the application with regard to the inter-process communication-based data communication between motion-sensing equipment middleware and said application.

The establishment of a private protocol for both said motion-sensing equipment middleware and the application ensures that the application can recognize the data information sent to said application by the motion-sensing equipment middleware and that the motion-sensing equipment middleware can recognize the instruction information sent by the application to said motion-sensing equipment middleware.

The establishment of a private protocol for both said motion-sensing equipment middleware and the application ensures that the application can acquire all of the information contained in the data information based on said private protocol and that the motion-sensing equipment middleware can acquire all of the information contained in said instruction information based on said private protocol. Data loss is thus avoided.

After the step of the application receiving said motion-sensing data packets described in step S105 above, said application resolves said motion-sensing data packets in accordance with said private protocol to obtain standardized equipment data.

### Embodiment 2

The embodiment described above provides a method for exchanging data between a smart display terminal and motion-sensing equipment. The present application further provides a corresponding device for exchanging data between a smart display terminal and motion-sensing equipment.

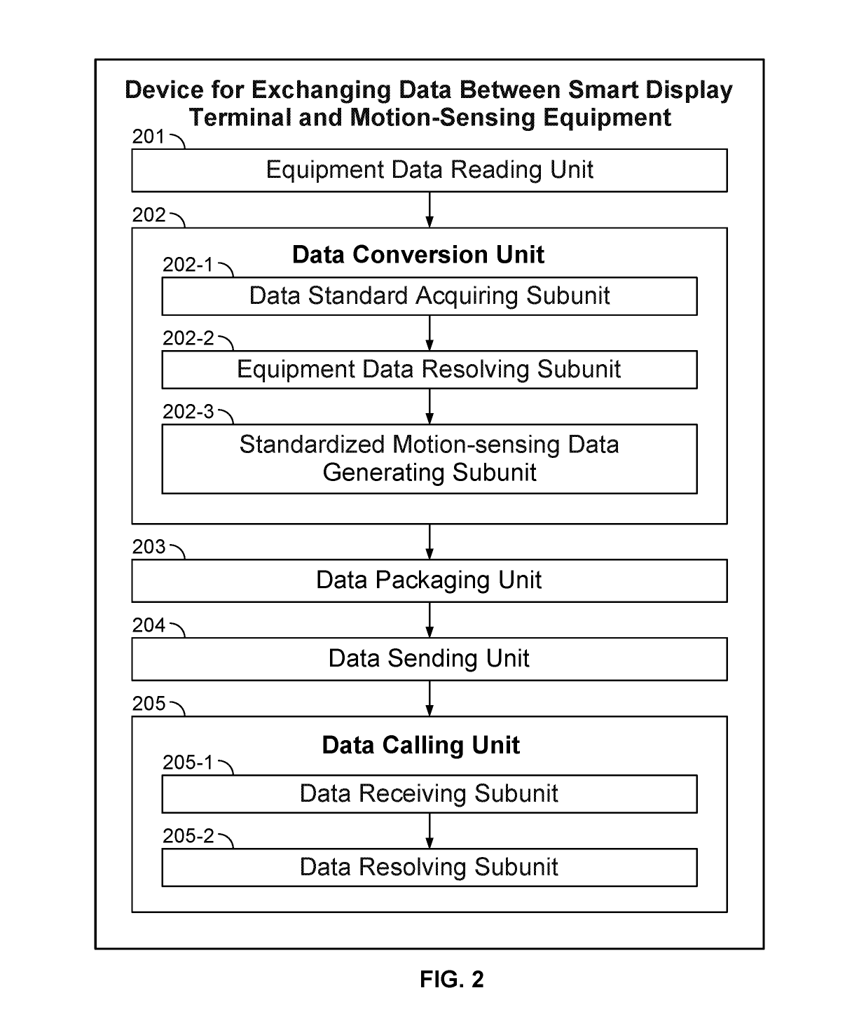

Refer to FIG. 2, which presents a diagram of a device for exchanging data between a smart display terminal and motion-sensing equipment as provided by a second embodiment of the present application.

Since the device embodiment is basically similar to the method embodiment, it is described more simply. Please see the explanations of the corresponding sections of the method embodiment. The device embodiment described below is merely illustrative.

As described by the present application, said device for exchanging data between a smart display terminal and motion-sensing equipment comprises:

an equipment data reading unit 201, for reading equipment data uploaded by motion-sensing equipment on the basis of a smart display terminal;

a data conversion unit 202, for converting said equipment data into standardized motion-sensing data;

a data calling unit 205, for implementing the reading by an application of said standardized motion-sensing data.

Optionally, said data conversion unit 202 comprises:

a data standard acquiring subunit 202-1 for acquiring the data format standard used by the motion-sensing equipment corresponding to said equipment data;

an equipment data resolving subunit 202-2 for resolving said equipment data according to said data format standard and generating motion-sensing data;

a standardized motion-sensing data generating subunit 202-3, for converting said motion-sensing data into standardized motion-sensing data on the basis of a preset conversion algorithm.

Optionally, said device for exchanging data between a smart display terminal and motion-sensing equipment comprises:

a data packaging unit 203, for packaging said standardized motion-sensing data according to a private protocol and obtaining motion-sensing data packets;

a data sending unit 204, for sending said motion-sensing data packets to an application.

Optionally, said data calling unit 205 comprises:

a data receiving subunit 205-1, for the application receiving said motion-sensing data packets;

a data resolving subunit 205-2, said application resolving said motion-sensing data packets in accordance with said private protocol to obtain standardized equipment data.

### Embodiment 3

The embodiment described above provides a method for exchanging data between a smart display terminal and motion-sensing equipment.

In addition, the present application further provides motion-sensing equipment middleware for exchanging data between a smart display terminal and motion-sensing equipment. It is: used in the aforesaid method for exchanging data between a smart display terminal and motion-sensing equipment, used in the step of converting said equipment data into standardized motion-sensing data, and used in the step whereby the smart display terminal sends instructions to said motion-sensing equipment via said application programming interface.

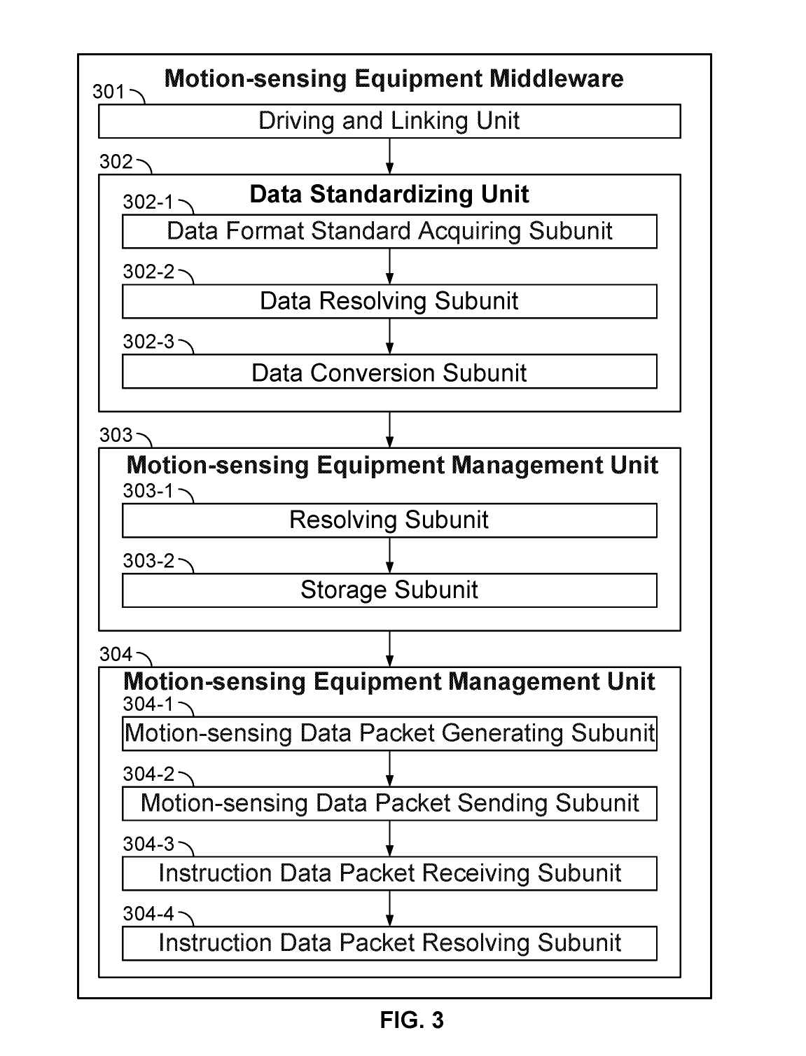

Refer to FIG. 3, which presents a diagram of motion-sensing equipment middleware for exchanging data between a smart display terminal and motion-sensing equipment as provided by a third embodiment of the present application.

In the present application, the role of said motion-sensing equipment middleware is to convert the equipment data uploaded by said motion-sensing equipment into standardized motion-sensing data having a unified data format. If said motion-sensing equipment middleware is not present, then even if an application were able to read the equipment data uploaded by the motion-sensing equipment directly on the basis of the smart display equipment, it would not be able to recognize equipment data of different data format standards, much less could it be called. The application would not be able to exchange data with motion-sensing equipment, and the method of exchanging data between said smart display terminal and motion-sensing equipment could not be implemented. To summarize the above, the motion-sensing equipment middleware is indispensable for the method of exchanging data between said smart display terminal and motion-sensing equipment.

Said motion-sensing equipment middleware for exchanging data between a smart display terminal and motion-sensing equipment comprises: a driving and linking unit 301, a data standardizing unit 302, a motion-sensing equipment management unit 303, and a data communication unit 304.

The driving and linking unit 301 is for reading equipment data uploaded by the motion-sensing equipment based on the smart display terminal and for sending commands issued by the application program.

Said equipment data comprises data collected by built-in sensors in the motion-sensing equipment and equipment information data. Said equipment information data comprises: equipment ID of the motion-sensing equipment, equipment manufacturer ID, equipment name and sensor model, type, etc. Motion-sensing equipment whose equipment ID, equipment manufacturer ID, equipment name and sensor model and type may also have different data format standards for the corresponding equipment data.

Said driving and linking unit 301 serves as the interface between said motion-sensing equipment and the smart display terminal. This interface is implemented by an interface driver. Said interface driver may be a USB driver, a WiFi driver, or a Bluetooth driver. In addition, it may also be another driver, such as an infrared driver. No restrictions are imposed in this regard.

If said motion-sensing equipment is connected to said smart display terminal via a USB interface, data communication will be provided between said motion-sensing equipment and said smart display terminal via the USB driver. In the present embodiment, said motion-sensing equipment uploads the equipment data which it itself has collected via a USB interface to the display terminal. In addition, the process whereby said motion-sensing equipment uploads equipment data via a WiFi driver or a Bluetooth driver to a smart terminal is similar to the process whereby the motion-sensing equipment uploads equipment via a USB interface to the smart display terminal and will not be discussed further here.

Said data standardizing unit 302 is for converting said equipment data into standardized motion-sensing data.

After the motion-sensing equipment middleware, based on the driving and linking unit 301, receives the equipment data uploaded by the motion-sensing equipment, said motion-sensing equipment middleware, based on the data standardizing unit 302, reads the equipment data and converts the equipment data into standardized motion-sensing data. Said standardized motion-sensing data is data generated on the basis of a unified data format standard from the equipment data of different format standards corresponding to different motion-sensing equipment.

Said data standardizing unit 302 comprises: a data format standard acquiring subunit 302-1, a data resolving subunit 302-2, and a data conversion subunit 302-3.

The data format standard acquiring subunit 302-1 is for acquiring the data format standard used by the motion-sensing equipment corresponding to said equipment data.

If said data standardizing unit 302 is to convert the equipment data uploaded by said motion-sensing equipment into standardized motion-sensing data, an important prerequisite is that the data standardizing unit 302 first be able to recognize equipment data of different data format standards uploaded from different motion-sensing equipment. In the present embodiment, the data format standard acquiring subunit 302-1 in said data standardizing unit 302 acquires data format standards corresponding to motion-sensing equipment provided by different motion-sensing equipment factories and stores them. Only after it acquires data format standards corresponding to motion-sensing equipment provided by different motion-sensing equipment factories can said data standardizing unit 302 recognize the equipment data uploaded by said motion-sensing equipment and complete the conversion of said equipment data into standardized motion-sensing data, which is a prerequisite of data preparation.

The data resolving subunit 302-2 is for resolving said equipment data according to said data format standard and generating motion-sensing data.

Said motion-sensing data is data that can represent the movement (i.e., user motion-sensing action) characteristics of motion-sensing equipment. Said data resolving subunit 302-2 resolves said equipment data on the basis of the data format standard that corresponds to the motion-sensing equipment provided by the motion-sensing equipment factory and that was acquired by the aforesaid data format standard acquiring subunit 302-1, and it converts the resolved equipment data through analysis and computations into motion-sensing data. Please note that, in addition, said motion-sensing data has a one-to-one correspondence with data format standards. That is, one type of motion-sensing equipment corresponds to the motion-sensing data of one data format standard. The data format standards of motion-sensing data corresponding to different motion-sensing equipment differ from each other.

The data conversion subunit 302-3 is for converting said motion-sensing data on the basis of a preset conversion algorithm into standardized motion-sensing data. Said standardized motion-sensing data is motion-sensing data that represents motion-sensing equipment movement characteristics or user motion-sensing actions on the basis of a unified standard. That is, it converts the motion-sensing data of different data format standards acquired by the data resolving subunit 302-2 into motion-sensing data based on a unified standard.

In the present embodiment, said data conversion subunit 302-3 converts said motion-sensing data on the basis of a preset conversion algorithm into unified-standard motion-sensing data, i.e., standardized motion-sensing data.

Said conversion algorithm is written on the basis of the relationship between data format standards of said motion-sensing data and the data format standard of standardized motion-sensing data.

Said motion-sensing equipment management unit 303 is for managing the motion-sensing equipment that is connected to said smart display terminal or the equipment data corresponding to the motion-sensing equipment.

Said motion-sensing equipment management unit 303 comprises: a resolving subunit 303-1 and a storage subunit 303-2.

The resolving subunit 303-1 resolves said standardized motion-sensing data and obtains equipment characteristic information.

Said equipment data comprises the data collected by built-in sensors in motion-sensing equipment and equipment information data. Furthermore, said standardized motion-sensing data also comprises data collected by sensors and equipment information data. Said equipment information data comprises: equipment ID of the motion-sensing equipment, equipment manufacturer ID, equipment name and sensor model, type, etc. Said equipment characteristic information is equipment data information, e.g., the equipment ID of the motion-sensing equipment that can determine the motion-sensing equipment.

The storage subunit 303-2 is for storing said standardized motion-sensing data in the data storage area corresponding to said equipment characteristic information.

The role of said storage subunit 303-2 is to store different standardized motion-sensing data in different data storage areas. Moreover, the standardized motion-sensing data stored in the data storage area corresponding to the same equipment characteristic information is kept updated.

Data updating is implemented when new standardized motion-sensing data is generated for one piece of motion-sensing equipment, and said new standardized motion-sensing data updates the standardized motion-sensing data stored in said data storage area.

In the present embodiment, said data storage area corresponds to the equipment ID of the motion-sensing equipment. One equipment ID corresponds to one data storage area. Said data storage area may be one storage area within a database, or it may be another data storage unit. No restriction is imposed in this regard.

Said data communication unit 304 performs data communication with said application on the basis of inter-process communication.

Said motion-sensing equipment middleware runs in an independent process.

Likewise, said application runs in an independent process. A form of inter-process communication is employed to achieve data communication between said motion-sensing equipment middleware and said application, and in this way data is exchanged between said motion-sensing equipment middleware and said application. Said forms of inter-process communication include message queues, memory sharing, and sockets. Other forms may be employed in addition to these. No restriction is imposed in this regard.

Said data communication unit 304 comprises: a motion-sensing data packet generating subunit 304-1, a motion-sensing data packet sending subunit 304-2, an instruction data packet receiving subunit 304-3, and an instruction data packet resolving subunit 304-4.

The motion-sensing data packet generating subunit 304-1 is for packaging said standardized motion-sensing data according to a private protocol to obtain motion-sensing data packets.

In order to ensure the consistency and validity of the data of both the motion-sensing equipment middleware and the application, a unified data standard, namely a private protocol, is reached between the motion-sensing equipment middleware and the application with regard to the inter-process communication-based data communication between motion-sensing equipment middleware and said application.

The establishment of a private protocol for both said motion-sensing equipment middleware and the application ensures that the application can recognize the data information sent to said application by the motion-sensing equipment middleware and that the motion-sensing equipment middleware can recognize the instruction information sent by the application to said motion-sensing equipment middleware.

The establishment of a private protocol for both said motion-sensing equipment middleware and the application ensures that the application can acquire all of the information contained in said data information based on said private protocol and that the motion-sensing equipment middleware can acquire all of the information contained in said instruction information based on said private protocol. Data loss is thus avoided.

After both said motion-sensing equipment middleware and the application attain a private protocol, the motion-sensing equipment middleware packages said standardized data according to said private protocol and generates motion-sensing data packets.

After the motion-sensing equipment middleware acquires said motion-sensing data packets, it sends the motion-sensing data packets to the application.

After the application receives said motion-sensing data packets, it resolves the motion-sensing data packets according to said private protocol, obtains the standardized motion-sensing data, and performs the appropriate operations.

Similarly, after both said motion-sensing equipment middleware and the application attain a private protocol, the application packages said instruction data according to said private protocol and generates instruction data packets.

After the application acquires said instruction data packets, it sends the instruction data packets to the motion-sensing equipment middleware.

After the motion-sensing equipment middleware receives said instruction data packets, it resolves the instruction data packets according to said private protocol and obtains the standardized instruction data.

The motion-sensing data packet sending subunit 304-2 is for sending said motion-sensing data packets to said application.

Refer to the explanation for the motion-sensing data packet generating subunit 304-1 described above. It will not be discussed further here.

The instruction data packet receiving subunit 304-3 is for receiving instruction data packets sent by said application.

Refer to the explanation for the motion-sensing data packet generating subunit 304-1 described above. It will not be discussed further here.

The instruction data packet resolving subunit 304-4 is for resolving said instruction data packets into standardized instruction data according to a private protocol.

Regarding said motion-sensing data packet sending subunit 304-2, instruction data packet receiving subunit 304-3, and instruction data packet resolving subunit 304-4, refer to the explanation for the motion-sensing data packet generating subunit 304-1 described above. They will not be discussed further here.

Under the prior art, the application cannot be compatible with motion-sensing equipment. For a particular model of motion-sensing equipment provided by a particular factory, there will only be one type or one series of games that can be compatible with said motion-sensing equipment. In addition, neither another application nor a third party application can be compatible with said motion-sensing equipment. For example, in the case of Nintendo or Xiao Bawang, only the game software especially developed for the corresponding game can be installed. The majority of games on the market cannot be installed or implemented. Said motion-sensing equipment middleware provided by the present embodiment acquires the data format standards employed for the equipment data corresponding to the motion-sensing equipment of different equipment manufacturers. It then converts equipment data according to the corresponding data format standard into motion-sensing data that represents the movement characteristics of motion-sensing equipment. Moreover, it converts the motion-sensing data into standardized motion-sensing data having a unified data format according to a preset conversion algorithm, and it unifies the data transmission format for the motion-sensing equipment. Lastly, it provides said standardized motion-sensing data to an application, enabling the application to be compatible with motion-sensing equipment produced by different manufacturers.

### Embodiment 4

The embodiments described above provide a method for exchanging data between a smart display terminal and motion-sensing equipment and motion-sensing equipment middleware for exchanging data between a smart display terminal and motion-sensing equipment. The latter is used in the above-described method for exchanging data between a smart display terminal and motion-sensing equipment and is used in the step of converting said equipment data into standardized motion-sensing data. It is also used in the step whereby the smart display terminal sends instructions to said motion-sensing equipment via said application programming interface. In addition, the present application further provides a software development kit for exchanging data between a smart display terminal and motion-sensing equipment. It is used for matching with the above-described motion-sensing equipment middleware that is used for exchanging data between a smart display terminal and motion-sensing equipment.

In the present application, the role of said motion-sensing equipment middleware is to convert the equipment data uploaded by the motion-sensing equipment into standardized motion-sensing data with a unified data format. The role of said software development kit is to provide a development standard and basis for software developers to provide software (applications and games) matched with the motion-sensing equipment and to provide interface tools so that said software can access said standardized motion-sensing data.

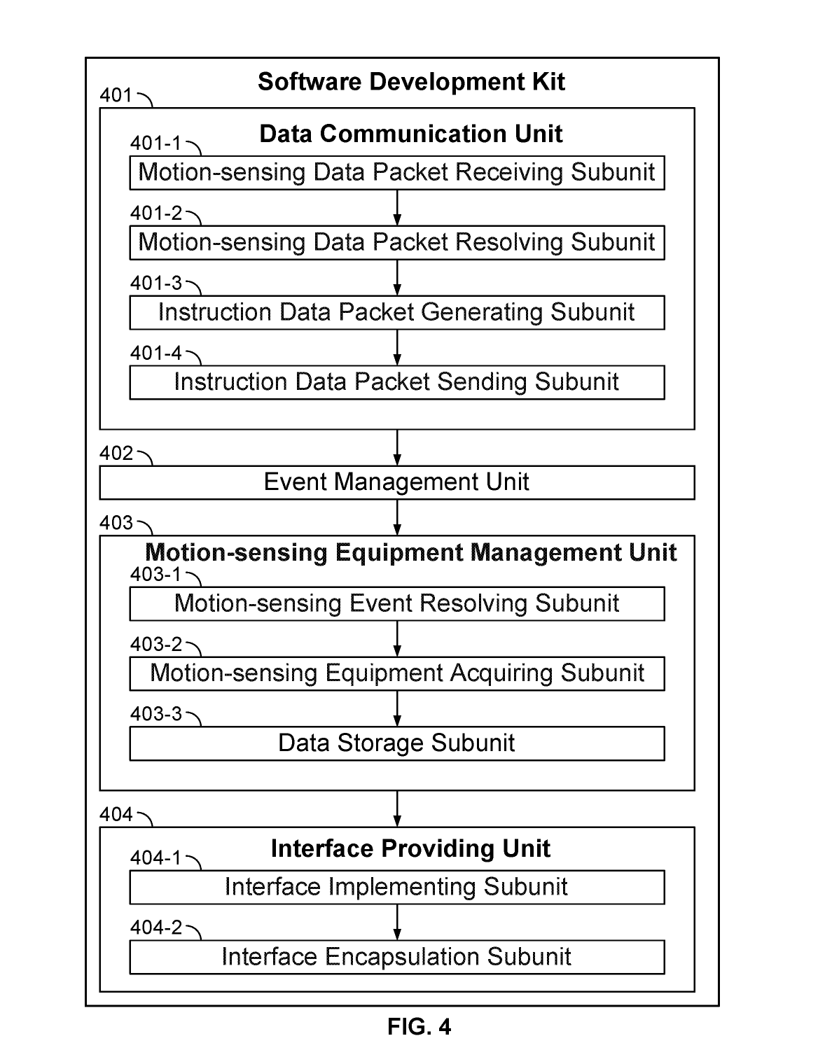

Refer to FIG. 4, which presents a diagram of a software development kit for exchanging data between a smart display terminal and motion-sensing equipment as provided by a fourth embodiment of the present application.

Said software development kit comprises a data communication unit 401, an event management unit 402, a motion-sensing equipment management unit 403, and an interface providing unit 404.

In the present embodiment, said software development kit refers to a set of application development interfaces (APIs) that monitor, read, operate, and manage smart display terminal motion-sensing equipment and the corresponding data of motion-sensing equipment. The actual form in which it is ultimately provided is a number of application files. Applications (including games) can call the application development interfaces provided by the software development kit.

Please note that, in the present embodiment, said software development kit itself does not run as an independent process, but runs only in application processes that call it. Said motion-sensing equipment middleware runs in independent processes. Data communication between said motion-sensing equipment middleware and said software development kit is implemented through a form of inter-process communication. Said forms of inter-process communication include: message queues, shared memory, and sockets. Other forms may be employed in addition to these. No restriction is imposed in this regard.

Said data communication unit 401 conducts data communication with motion-sensing equipment middleware on the basis of inter-process communication.

Said motion-sensing equipment middleware runs in independent processes. Likewise, said application runs in independent processes. To achieve data communication between said motion-sensing equipment middleware and said application, a form of inter-process communication is employed. In this way, data exchange between said motion-sensing equipment middleware and said application is achieved. Said forms of inter-process communication include: message queues, shared memory, and sockets. Other forms may be employed in addition to these. No restriction is imposed in this regard.

Said data communication unit 401 comprises: a motion-sensing data packet receiving subunit 401-1, a motion-sensing data packet resolving subunit 401-2, an instruction data packet generating subunit 401-3, and an instruction data packet sending subunit 401-4.

The motion-sensing data packet receiving subunit 401-1 is for receiving motion-sensing data packets sent by said motion-sensing equipment middleware.

In order to ensure the consistency and validity of the data of both the motion-sensing equipment middleware and the application, a unified data standard, namely a private protocol, is reached between the motion-sensing equipment middleware and the application with regard to the inter-process communication-based data communication between said motion-sensing equipment middleware and said application.

The establishment of a private protocol for both said motion-sensing equipment middleware and the application ensures that the application can recognize the data information sent to said application by the motion-sensing equipment middleware and that the motion-sensing equipment middleware can recognize the instruction information sent by the application to said motion-sensing equipment middleware.

In addition, the establishment of a private protocol for both said motion-sensing equipment middleware and the application ensures that the application can acquire all of the information contained in the data information based on said private protocol and that the motion-sensing equipment middleware can acquire all of the information contained in said instruction information based on said private protocol. Data loss is thus avoided.

After both said motion-sensing equipment middleware and the application attain a private protocol, the motion-sensing equipment middleware packages said standardized data according to said private protocol and generates motion-sensing data packets.

After the motion-sensing equipment middleware acquires said motion-sensing data packets, it sends the motion-sensing data packets to the application.

After the application receives said motion-sensing data packets, it resolves the motion-sensing data packets according to said private protocol, obtains the standardized motion-sensing data, and performs the appropriate operations.

Similarly, after both said motion-sensing equipment middleware and the application attain a private protocol, the application packages said instruction data according to said private protocol and generates instruction data packets.

After the application acquires said instruction data packets, it sends the instruction data packets to the motion-sensing equipment middleware.

After the motion-sensing equipment middleware receives said instruction data packets, it resolves the instruction data packets according to said private protocol, obtains the instruction data, and conducts the appropriate operations.

The motion-sensing data packet resolving subunit 401-2 is for resolving said motion-sensing data packets according to the private protocol and obtaining standardized motion-sensing data.

Refer to the explanation for the motion-sensing data packet receiving subunit 401-1 described above. It will not be discussed further here.

The instruction data packet generating subunit 401-3 is for packaging instruction data according to the private protocol and obtaining instruction data packets.

Refer to the explanation for the motion-sensing data packet receiving subunit 401-1 described above. It will not be discussed further here.

The instruction data packet sending subunit 401-4 is for sending said instruction data packets to said motion-sensing equipment middleware.

Regarding said motion-sensing data packet resolving subunit 401-2, instruction data packet generating subunit 401-3, and instruction data packet sending subunit 401-4, refer to the explanation for the motion-sensing data packet receiving subunit 401-1 described above. They will not be discussed further here.

Said event management unit 402 implements operational control over said application based on various preset motion-sensing events. Events are a kind of mechanism for inter-object communication. There are many kinds of events. Common events include mouse single-click events, mouse sliding events, and button single-click events. The role of events is to help the user complete things that the user wants to complete, such as:

In the case of a mouse single-click event, an action of some sort will definitely occur after single-clicking the mouse. Examples include exiting a window, refreshing a page, or submitting data. At these times, the operation of single-clicking a mouse will trigger a mouse single-click event. All events are corresponding. In the case of a mouse single-click event, it is only after the operation of single-clicking a mouse has been executed that the mouse single-click event will be triggered and a method or an attribute within the mouse single-click event will be executed.

In the present embodiment, the steps whereby said event management unit 402 implements operational control over said application based on various preset motion-sensing events are as follows:

1) Different types of motion-sensing events are defined according to the data types of said standardized motion-sensing data. Said motion-sensing events include key-pressing events, sensor events, and/or air mouse events.

2) Said motion-sensing events are monitored by an event monitor. If said motion-sensing event is triggered, then the operational response corresponding to the motion-sensing event is executed and operational control over said application is implemented.

In addition, please note that said event management unit 402 may further employ an event-implementing method other than the present embodiment to affect implementation. An example would be C# event implementation. No restriction is imposed in this regard.

The motion-sensing equipment management unit 403 is for managing the motion-sensing equipment that accesses said smart display terminal or the equipment data corresponding to the motion-sensing equipment.

Said motion-sensing equipment management unit 403 comprises: a motion-sensing event resolving subunit 403-1, a motion-sensing equipment acquiring subunit 403-2, and a data storage subunit 403-3.

Said motion-sensing event resolving subunit 403-1 is for resolving said motion-sensing event and for obtaining equipment characteristic information and standardized motion-sensing data.

As for the various motion-sensing events implemented in the motion-sensing event management unit 402 described above, once a motion-sensing event of said motion-sensing events is triggered, then the motion-sensing event resolving subunit 403-1 resolves the motion-sensing event and at the same time obtains the equipment characteristic information and standardized motion-sensing data corresponding to the motion-sensing event.

Said motion-sensing equipment acquiring subunit 403-2 is for using said equipment characteristic information to acquire the motion-sensing equipment corresponding to the equipment characteristic information from a motion-sensing equipment list.

Said motion-sensing equipment list is a motion-sensing equipment list composed of all motion-sensing equipment connected to said smart display terminal.

The aforesaid motion-sensing event resolving subunit 403-1 obtains equipment characteristic information and standardized motion-sensing data by resolving the motion-sensing event. Said motion-sensing equipment acquiring subunit 403-2 uses the equipment characteristic information to search the motion-sensing equipment list and acquire the motion-sensing equipment corresponding to the equipment characteristic information. In the present embodiment, the motion-sensing equipment acquiring subunit 403-2 uses the motion-sensing equipment ID to look up the motion-sensing equipment corresponding to the ID in the motion-sensing equipment list.

Said data storage subunit 403-3 is for storing said standardized motion-sensing data in the data storage area corresponding to said equipment characteristic information.

The role of said data storage subunit 403-3 is to store different standardized motion-sensing data in different data storage areas. Moreover, for the same equipment characteristic information, it keeps the standardized data stored in the corresponding data storage area updated.

After a new motion-sensing event is triggered and new standardized motion-sensing data is obtained by resolving the motion-sensing event, said new standardized motion-sensing data is used to update the standardized motion-sensing data stored in said data storage areas for the same motion-sensing equipment. Data updating is thus achieved.

In the present embodiment, said storage area corresponds to the equipment ID of the motion-sensing equipment. One equipment ID corresponds to one data storage area. Said data storage area could be a storage area within a database, or it could be another data storage unit. No restriction is imposed in this regard.

Said data storage subunit 403-3, motion-sensing equipment acquiring subunit 403-2, and motion-sensing event resolving subunit 403-1 jointly maintain said motion-sensing equipment list.

Said motion-sensing event resolving subunit 403-1 first resolves the triggered event in the event management unit 402 and obtains the equipment characteristic information and standardized motion-sensing data corresponding to the motion-sensing event.

Said motion-sensing equipment acquiring subunit 403-2 uses the equipment characteristic information to search the motion-sensing equipment list and acquire the motion-sensing equipment corresponding to the equipment characteristic information.

Said data storage subunit 403-3 stores said standardized motion-sensing data in a data storage area corresponding to said equipment characteristic information. Said data storage area could be one storage area in a database, or it could be another data storage unit. No restriction is imposed in this regard.

The interface providing unit 404 is for providing application programming interfaces to the application.

Said interface providing unit 404 comprises an interface implementing subunit 404-1 and an interface encapsulation subunit 404-2.

The interface implementing subunit 404-1 implements said application programming interface on the basis of said motion-sensing equipment management unit 403.

Please note that said application programming interface is implemented in different programming languages, such as Java, C, and C++. The interface encapsulation subunit 404-2 is for packaging said application programming interface, for compiling it into a library file, and for exporting it.

According to the different application programming language environments, said software development kit carries out interface encapsulation of the standardized motion-sensing data and equipment characteristic information provided by the motion-sensing equipment management unit 403. Typical language environments include Java, C, and C++. Moreover, said software development kit ultimately supplies the information externally in the form of application programming library files.

For example:

The process for encapsulating interfaces with Java is as follows:

1) Use Java to define a motion-sensing equipment class, a motion-sensing equipment management class, a motion-sensing event class, and so on.

2) Define the application programming interfaces (API) that said motion-sensing equipment class, motion-sensing equipment management class, and motion-sensing event class need to make available externally, and use the motion-sensing equipment management unit 403 as a basis for implementing said application programming interfaces (API). In addition, the motion-sensing equipment management unit 403 compiles in C/C++. Therefore, they are encapsulated in Java. Java's JNI is needed to call them.

3) Package said application programming interfaces (API), compile them into library files, and export them. Moreover, export software development kit handbook documentation and make them available to application program developers.

In addition, it is possible to use other programming languages to implement the function that is completed by said interface providing unit 404 for providing application interfaces encapsulated as multiple languages to application software. The present embodiment imposes no restriction in this regard.

Under the prior art, an application developed by a company or a developer is compatible only with one or more specific types of motion-sensing equipment that it was oriented towards when it was developed. It is incompatible with other motion-sensing equipment. In the present embodiment, software development kits are used to provide unified application programming interfaces to developers. All of the applications developed by developers using the software development kits are compatible with motion-sensing equipment.

Although the present application makes use of preferred embodiments to disclose the above, they are not used to limit the present application. Any person skilled in the art may make possible alterations and modifications without departing from the spirit and scope of the present application. Therefore, the protected scope of the present application shall be the scope delimited by the claims of the present application.

In one typical configuration, said computer equipment comprises one or more processors (CPUs), input/output interfaces, network interfaces, and memory.

Memory may include such forms as volatile memory in computer-readable media, random access memory (RAM), and/or non-volatile memory, such as read-only memory (ROM) or flash memory (flash RAM). Memory is an example of a computer-readable medium.

1. Computer-readable media, including permanent and non-permanent and removable and non-removable media, may achieve information storage by any method or technique. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment, or any other non-transmission media that can be used to store information that is accessible to computers. As defined in this document, computer-readable media does not include transitory computer-readable media, (transitory media), such as modulated data signals and carrier waves.

2. A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, embodiments of the present application may employ one or more forms of computer products that implement computer-operable storage media (including but not limited to magnetic disk storage devices, CD-ROMs, and optical storage devices) containing computer-operable computer code.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1-21. (canceled)

22. A method, comprising:
obtaining equipment information data that is from one or more sensors connected to a display equipment;
converting the equipment information data to standard motion-sensing information;
communicating the standard motion-sensing information to one or more applications according to a predefined protocol; and
controlling the display equipment based at least in part on the standard motion-sensing information received by the one or more applications.

23. The method of claim 22, further comprising:
collecting, by the one or more sensors, the equipment information data.

24. The method of claim 23, further comprising:
sending, by the one or more sensors, the equipment information data to the display equipment.

25. The method of claim 24, wherein the equipment information data is sent to the display equipment over one or more communication interfaces.

26. The method of claim 25, wherein the one or more communication interfaces includes one or more of a USB interface, a WiFi interface, or a Bluetooth interface.

27. The method of claim 22, further comprising:
determining a format corresponding to the equipment information data.

28. The method of claim 27, wherein the format is based at least in part on the one or more sensors.

29. The method of claim 22, wherein the equipment information data comprises one or more of an equipment identifier of the one or more sensors, an equipment manufacturer identifier of the one or more sensors, a model identifier of the one or more sensors, a type of the one or more sensors.

30. The method of claim 22, further comprising:
extracting, from the equipment information data, information associated with motion characteristics corresponding to the one or more sensors.

31. The method of claim 30, wherein converting the equipment information data to standard motion-sensing information comprises converting the information associated with motion characteristics corresponding to the one or more sensors to the standard motion-sensing information.

32. The method of claim 1, further comprising:
packing the standard motion-sensing information according to the predefined protocol.

33. The method of claim 1, wherein the one or more applications operate using a format of data different than a native format of data of the one or more sensors.

34. The method of 33, wherein the one or more applications are not compatible with the native format of the one or more sensors.

35. The method of claim 1, further comprising:
determining a format corresponding to the equipment information data, wherein the equipment information data comprises one or more of an equipment identifier of the one or more sensors, an equipment manufacturer identifier of the one or more sensors, a model identifier of the one or more sensors, a type of the one or more sensors, and wherein the determining the format comprises:
obtaining, based at least on the equipment information data, the format from a mapping that stores a plurality of formats with corresponding ones of equipment identifiers corresponding to sensors, equipment manufacturer identifiers corresponding to sensors, model identifiers corresponding to sensors, and types of sensors based at least in part on the one or more sensors.

36. A device, comprising:
one or more processors configured to:
obtaining equipment information data that is from one or more sensors connected to a display equipment;
converting the equipment information data to standard motion-sensing information;
communicating the standard motion-sensing information to one or more applications according to a predefined protocol; and
controlling the display equipment based at least in part on the standard motion-sensing information received by the one or more applications; and
a memory coupled to the one or more processors and configured to provide the one or more processors with instructions.

37. A computer program product, the computer program product being embodied in a non-transitory computer readable storage medium and comprising computer instructions for:
obtaining equipment information data that is from one or more sensors connected to a display equipment;
converting the equipment information data to standard motion-sensing information;
communicating the standard motion-sensing information to one or more applications according to a predefined protocol; and
controlling the display equipment based at least in part on the standard motion-sensing information received by the one or more applications.

38. A system, comprising:
one or more sensors that operating configured to collect equipment information data using one or more native formats; and
a display equipment comprising:
one or more processors configured to:
obtaining equipment information data that is from one or more sensors connected to a display equipment;
converting the equipment information data from the one or more native formats to standard motion-sensing information;
communicating the standard motion-sensing information to one or more applications according to a predefined protocol; and
controlling the display equipment based at least in part on the standard motion-sensing information received by the one or more applications; and
a memory coupled to the one or more processors and configured to provide the one or more processors with instructions.
